(19) United States
(12) Patent Application Publication
(10) Pub. No.: US 2015/0278298 A1
(43) Pub. Date: Oct. 1, 2015

(54) APPARATUS AND METHOD FOR DISPLAYING IMAGE-BASED REPRESENTATIONS OF GEOGRAPHICAL LOCATIONS IN AN ELECTRONIC TEXT

(71) Applicant: NOKIA CORPORATION, Espoo (FI)

(72) Inventor: Sergey Boldyrev, Soderkulla (FI)

(73) Assignee: Nokia Corporation, ESPOO (FI)

(21) Appl. No.: 14/438,957

(22) PCT Filed: Nov. 6, 2012
(86) PCT No.: PCT/IB2012/056189

§ 371 Date: Apr. 28, 2015

(51) Int. Cl. G06F 17/30; H04L 29/12; H04L 12/58

(52) U.S. Cl. CPC G06F 17/30424; G06F 17/30477; H04L 51/04; H04L 61/609

(57) ABSTRACT

An apparatus comprising at least one processor; and at least one memory, the memory comprising computer program code stored thereon, the at least one memory and computer program code being configured to, when run on the at least one processor, cause the apparatus to: process a passage of electronic text to identify at least one word associated with a geographical location in the passage of electronic text; search for an image-based representation of the geographical location associated with the at least one identified word; and output the image-based representation of the geographical location to a display.

### TECHNICAL FIELD

The present disclosure relates to the field of user interfaces, associated methods, computer programs and apparatus. Certain disclosed aspects/examples relate to portable electronic devices, in particular, hand-portable electronic devices, which may be hand-held in use (although they may be placed in a cradle in use). Such hand-portable electronic devices include Personal Digital Assistants (PDAs), mobile telephones, smartphones, in car navigation systems and modules and other smart devices, and tablet PCs.

Portable electronic devices/apparatus according to one or more disclosed aspects/examples may provide one or more: audio/text/video communication functions such as tele-communication, video-communication, and/or text transmission (Short Message Service (SMS)/Multimedia Message Service (MMS)/emailing functions); interactive/non-interactive viewing functions (such as web-browsing, navigation, TV/program viewing functions); music recording/playing functions such as MP3 or other format, FM/AM radio broadcast recording/playing; downloading/sending of data functions; image capture functions (for example, using a digital camera); and gaming functions.

### BACKGROUND

Natural language processing (NLP) is concerned with interactions between computers and humans, and involves enabling computers to derive meaning from human language input.

The listing or discussion of a prior-published document or any background in this specification should not necessarily be taken as an acknowledgement that the document or background is part of the state of the art or is common general knowledge. One or more aspects/examples of the present disclosure may or may not address one or more of the background issues.

### SUMMARY

In a first aspect there is provided an apparatus comprising: at least one processor; and at least one memory, the memory comprising computer program code stored thereon, the at least one memory and computer program code being configured to, when run on the at least one processor, cause the apparatus to: process a passage of electronic text to identify at least one word associated with a geographical location in the passage of electronic text; search for an image-based representation of the geographical location associated with the at least one identified word; and output the image-based representation of the geographical location to a display. Thus the apparatus can identify words in a passage of text as being linked to a location. A search is carried out to find images (e.g., photos, movies, and maps) related to the identified locations, for output on a display. Thus a user may be able to see photographs, movies, and maps, relating to the locations they are reading about in a book, to enhance their reading experience.

The electronic text may be one of bounded text and unbounded text. Bounded text may be considered to be text which includes mark-up tags or formatting associated with one or more words in the text. For example, an e-book text may include geo-tags explicitly within the text. A geo-tagged word may be considered bounded text; for example, in the text “I want to visit Paris”, the word “Paris” may be geo-tagged and a user may be able to interact with the word (for example, by clicking on it) and information relating to Paris may be displayed to the user). Unbounded text may be considered to be text with no embedded geo-tags present, nor is any particular formatting or tagging of words/phrases present in the text.

The at least one word may be a single word, a frame, a segment, comprised in a frame, or comprised in a segment. A frame may be considered to be a templated segment, in that there is short-term understanding within the frame (e.g., the frame “he went to London” makes sense as a stand-alone passage of text). Semantics are present in the frame to logically link/place the frame within the surrounding text/description.

The apparatus is configured to identify at least two words each associated with a geographical location in the passage of electronic text; and based on the identified at least two words in the processed passage of electronic text, output an image-based representation of a route formed from the respective identified image-based representations of the identified at least two or more words. For example, in the text “I took the flight from New York to Boston”, the words “New York” and “Boston” may be identified, and the route from New York to Boston, for example as a flight path, may be output on a display.

Image-based representation encompasses, for example, one or more of two dimensional, three dimensional, augmented reality images for the geographical location of the identified word/route.

The apparatus may configured to output an image-based representation of the route formed from the respective identified image-based representations of the identified at least two or more words by searching for the respective image-based representations of the geographical locations and searching for corresponding interconnecting geographical locations for the identified image-based representations to form an interconnected route between the identified image-based representations of the identified at least two or more words. Thus, interconnecting geographical locations may be derived between the two locations, so for example, not only are the city centres of New York and Boston shown but also the their respective airports and points of interest along the routes between the respective city centres of New York and Boston.

The corresponding interconnecting geographical locations for the identified image-based representations may not explicitly be present in the passage of text. Thus, the apparatus may show images of locations which are not explicitly identified in the text but would be, for example, points of interest or other marking locations (e.g. where turns are made or junctions) on the route between the two locations.

The apparatus may be configured to store the outputted image-based representation of a route for later viewing. Thus a user may be able to store their favourite routes for later viewing without the need to re-process a passage of text to obtain the route.

The apparatus may be configured to identify at least two words each associated with a geographical location in the passage of electronic text as being associated with a particular narrator in the passage of electronic text; and output the image-based representation of a route based on the geographical locations associated with the at least two identified words for the particular narrator.

The apparatus may be configured to output a chronological image-based representation of a route between the geographical locations each associated with at least one identified word, by identifying one or more temporal cues in the passage of text; and using the one or more temporal cues and the geographical locations to output the chronological image-based representation of a route.

The apparatus may be configured to process the passage of electronic text by performing a syntactic check of the passage of electronic text to determine a grammatical structure of the text; and using the determined grammatical structure to identify the at least one word associated with a geographical location within a particular grammatical context in the passage of electronic text.

The apparatus may be configured to perform the syntactic check of the passage of electronic text by one or more of:
checking the passage of text for temporal cues;
checking the passage of text for geo-bound cues;
checking the passage of text for frames;
checking the passage of text for stop words;
determining a grammar of the passage of text and formally mapping the grammar of the electronic text to a known grammar structure; and
building a transition from the passage of text.

The apparatus may be configured to process the passage of electronic text by identifying one or more frames within the passage of electronic text, at least one of the one or more frames comprising the at least one word associated with a geographical location.

The apparatus may be configured to process the passage of electronic text by performing a semantic check of the electronic text to determine a meaning of the text, and using the determined meaning of the text to identify the at least one word associated with a geographical location within a particular semantic context.

The apparatus may be configured to process the passage of electronic text by performing sentence extraction to extract one or more sentences from the electronic text, and using the one or more extracted sentences to identify the at least one word associated with a geographical location within the context of the particular one or more extracted sentences.

The apparatus may be configured to perform sentence extraction to extract one or more sentences from the electronic text by:
lexical disambiguation of one or more frames identified in the text to minimise ambiguities in the one or more frames;
refining one or more frames identified in the text to minimise ambiguities in the one or more frames; and
checking one or more temporal cues in one or more frames identified in the text to minimise ambiguities in the one or more frames.

The apparatus may be configured to process the passage of electronic text by creating an event vector usable by the apparatus to output, based on the event vector, of an image-based representation of the at least one word associated with a geographical location.

The apparatus may be configured to process the passage of electronic text by creating an event vector, the event vector comprising one or more of:
a geographical location identified in the passage of text;
a temporal cue identified in the passage of text;
a geo-bound cue identified in the passage of text;
a frame identified in the passage of text; and
a stop word identified in the passage of text.

The apparatus may be configured to process the passage of electronic text by performing geo-filtering of the electronic text to filter out geographical information in the text; and using the filtered geographical information to identify the at least one word associated with a geographical location in the passage of electronic text.

The apparatus may be further configured to apply inference rules in one or more processing feedback loops to establish newly detected semantics or syntactic features in the passage of electronic text, in order to identify the at least one word associated with a geographical location in the passage of electronic text.

The apparatus may be configured to process the passage of electronic text to identify at least one word associated with a geographical location by comparison of the words in the electronic text against a list of known location words stored in a locations list; and matching at least one of the words in the electronic text with a known location word stored in the locations list.

The apparatus may be configured to receive the passage of electronic text as input, wherein the passage of electronic text is one of a static data stream or a fast-moving data stream.

The apparatus may be configured to output an image-based representation of the geographical location associated with the at least one identified word by one or more of:
presenting a user with a map showing the geographical location;
presenting a user with a historical map showing the geographical location based on one or more identified historical temporal cues in the passage of electronic text;
presenting a user with a street-level view of the geographical location;
presenting the user with one or more photographs associated with the geographical location; and
presenting the user with one or more movies associated with the geographical location.

The passage of electronic text may be one or more of: a plain text document, a rich text document, and a spoken word recording.

The apparatus may be: a portable electronic device, a mobile telephone, a smartphone, a personal digital assistant, an e-book, a tablet computer, a navigator, a desktop computer, a video player, a television, a user interface or a module for the same.

In a further aspect there is provided a method comprising:
processing a passage of electronic text to identify at least one word associated with a geographical location in the passage of electronic text;
searching for an image-based representation of the geographical location associated with the at least one identified word; and
outputting the image-based representation of the geographical location to a display.

In a further aspect there is provided a computer readable medium comprising computer program code stored thereon, the computer readable medium and computer program code being configured to, when run on at least one processor, perform at least the following:
process a passage of electronic text to identify at least one word associated with a geographical location in the passage of electronic text;
search for an image-based representation of the geographical location associated with the at least one identified word; and
output the image-based representation of the geographical location to a display.

In a further aspect there is provided computer program code configured to:
process a passage of electronic text to identify at least one word associated with a geographical location in the passage of electronic text;
search for an image-based representation of the geographical location associated with the at least one identified word; and
output the image-based representation of the geographical location to a display.

In a further aspect there is provided an apparatus comprising:
means for processing a passage of electronic text to identify at least one word associated with a geographical location in the passage of electronic text;
means for searching for an image-based representation of the geographical location associated with the at least one identified word; and
means for outputting the image-based representation of the geographical location to a display.

The present disclosure includes one or more corresponding aspects, examples or features in isolation or in various combinations whether or not specifically stated (including claimed) in that combination or in isolation. Corresponding means and corresponding functional units (e.g., route determiner, route displayer, cue identifier) for performing one or more of the discussed functions are also within the present disclosure.

Corresponding computer programs for implementing one or more of the methods disclosed are also within the present disclosure and encompassed by one or more of the described examples.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus according to the present disclosure;

FIG. 2 illustrates another example apparatus according to the present disclosure;

FIG. 3 illustrates another example apparatus according to the present disclosure;

FIGS. 4a-4b illustrate the apparatus in communication with a remote server or cloud;

FIGS. 5a-5c illustrate schematic flow diagrams of a method of processing data to provide a route;

FIGS. 6a-6b illustrate portions of text available to an apparatus;

FIGS. 7a-7e illustrate schematically visual representations of routes based on the text of FIGS. 6a-6b;

FIG. 8 illustrates a method according to the present disclosure; and

FIG. 9 illustrates a computer readable medium comprising computer program code according to the present disclosure.

### DESCRIPTION OF EXAMPLE ASPECTS

A portion of electronic text may contain words which have been manually identified as words relating to geographical locations. For example, a portion of text may read “I went from Scarborough to Leeds last week on the train”. The words “Scarborough” and “Leeds” may each be manually identified with a “geo-tag”. A geo-tag is an item of identification metadata associated with a word or phrase related to geographical location in a medium such as text. A geo-tag may be generally associated with a geographical location word or phrase by manually identifying the word or phrase with geographical location information. Other media, such as photographs, may generally be geo-tagged by, for example, capturing GPS information at the time of recording the photograph/media, or manually associating the photograph/media with a map location. The identification metadata of a geo-tag may include latitude and longitude coordinates, altitude, bearing, accuracy data and place names. Therefore, geographical location specific information can be associated with a word which is identified as a geographical location, and geo-tagged as such.

The term “geo-coding” refers to identifying a geographical location word or phrase, and finding associated geographical coordinates such as latitude and longitude for that geographical location. Geo-coding may be used with geo-tagging to mark up a portion of text and provide location information such as links to maps and images for each geo-tagged item.

Natural language processing (NLP) is concerned with interactions between computers and humans, and involves enabling computers to derive meaning from human language input. NLP may be used to identify particular categories of words and phrases from a portion of text. It is possible to use NLP to derive meaning from words or phrases indicating locations. Such words may include locations such as cities (e.g., “Paris”), countries (e.g., “Spain”) and groups of words such as street names (e.g., “Waterloo Road”). It may also be possible to use NLP to derive, for example, time cues, such as years (e.g., “1864”), months (e.g., “January”), times (e.g., “half past seven”), and durations of time (e.g., “for three weeks”). A particular word or phrase may be identified as belonging to a particular category of word by comparing the word or phrase to a reference list/database of words or phrases, in which each word or phrase has previously been categorised. Thus the word “London” may be identified as a location by searching a dictionary for the term “London” and finding that it has been categorised as a location.

It may be advantageous for a computer-based system to be able to identify geographical location words and phrases in a portion of text by using NLP, and associate each of the identified words with a geographical location. Thus it may be advantageous for a computer based system to be able to take as input, for example, “I went from Scarborough to Leeds last week on the train”, identify the words “Scarborough” and “Leeds” as geographical location words, and associate or assign a geographical identifier to each identified geographical location word such that the geographical location may be identified on a map. Thus the identified geographical location “Leeds” in a piece of electronic text may be identified by an apparatus, and the coordinates “53.8100° N, 1.5500° W” (the latitude and longitude coordinates for Leeds) may be associated with the word Leeds, so that a user is provided with information such as a map of Leeds, or a map of the UK with the location of Leeds marked on the map. Of course, the information such as the map of Leeds may be provided by some other way without first identifying the coordinates of Leeds.

The ability for an apparatus or a computer based system to automatically identify and “geo-tag” words relating to geographic location may be advantageously used to provide an interactive map service for a user. Thus after the identification and automatic geo-tagging of a geographical location in an item of text by an apparatus, the user may be able to readily interact with the text (for example, by touching a geo-tagged word on a touch sensitive display of a portable electronic device), and a map or photograph of the location may be presented.

Further still, it may be advantageous for a computer-based system to identify and geo-tag a series of geographical locations, and provide the user with an interactive route based on those identified locations. Thus in the text “he ran from Green Park tube station to Piccadilly Circus”, the locations “Green Park tube station” and “Piccadilly Circus” may be identified and geo-tagged by the apparatus/computer based system, and a street-level view interactive map may be displayed to the user indicating a route from Green Park tube station, along Piccadilly, to Piccadilly Circus (and/or the respective positions of Green Park tube station and Piccadilly Circus).

For more complex portions of text, it may be advantageous for an apparatus/computer-based system to be able to recognise geographical locations and time cues (such as “in 1860” or “in January”) or other semantic cues (such as “he turned left”, “he quickly ran”. In this way a user may be provided with a more accurate (e.g., based on the time period, or actual route taken) visual representation of a location, map or street-level view, for example, via presentation in a particular style or by accurately/logically representing a route taken by a character in a portion of text. Thus not only would the locations be identified as static points, the route taken between those points would be determined logically from the text and a user may be provided with a virtual tool to “tread the path”, in the virtual world, which is taken by characters in a story, for example.

Embodiments of the present disclosure may be used to provide one or more of the above advantages and functionality.

Thus a user reading a piece of text which has no illustrations may be able to obtain a visual representation of the locations mentioned in the text to enhance their reading experience. By an apparatus searching for images relating to locations identified in the text, and plotting/outputting a route/image-based representation of a geographical location described in a piece of text based on the identified location words, a user may be able to visualise the locations discussed in the text, so that the user has a “virtual tool” for obtaining, for example, photographs, maps and/or movies of routes described in the text they are reading.

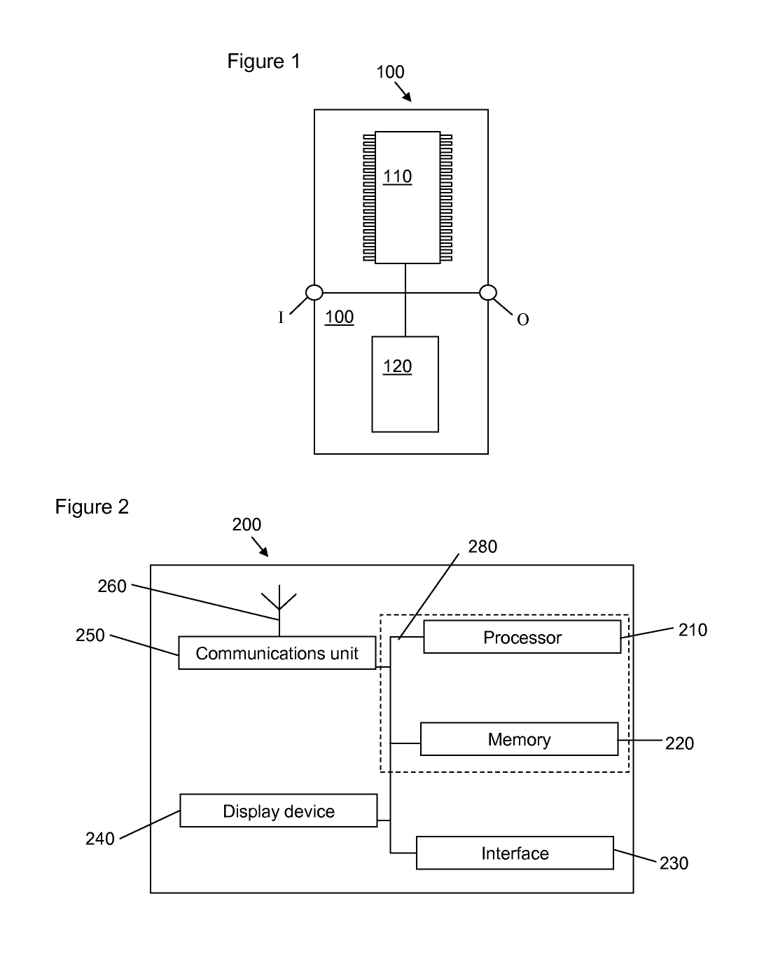

FIG. 1 shows an apparatus 100 comprising a processor 110, memory 120, input I and output O. In this example only one processor and one memory are shown but it will be appreciated that other examples may use more than one processor and/or more than one memory (for example, the same or different processor/memory types). The apparatus 100 may be an application specific integrated circuit (ASIC) for a portable electronic device. The apparatus 100 may also be a module for a device, or may be the device itself, wherein the processor 110 is a general purpose CPU and the memory 120 is general purpose memory.

The input I allows for receipt of signalling (for example, by wired or wireless means e.g., Bluetooth or over a WLAN) to the apparatus 100 from further components. The output O allows for onward provision of signalling from the apparatus 100 to further components. In this example the input I and output O are part of a connection bus that allows for connection of the apparatus 100 to further components. The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (such as solid state memory, a hard drive, ROM, RAM, Flash or other memory) that stores computer program code. This computer program code stores instructions that are executable by the processor 110, when the program code is run on the processor 110. The internal connections between the memory 120 and the processor 110 can be understood to provide active coupling between the processor 110 and the memory 120 to allow the processor 110 to access the computer program code stored on the memory 120.

In this example the input I, output O, processor 110 and memory 120 are electrically connected internally to allow for communication between the respective components I, O, 110, 120, which in this example are located proximate to one another as an ASIC. In this way the components I, O, 110, 120 may be integrated in a single chip/circuit for installation in an electronic device. In other examples one or more or all of the components may be located separately (for example, throughout a portable electronic device such as devices 200, 300, 500, 600, 700) or through a “cloud”, and/or may provide/support other functionality.

One or more examples of the apparatus 100 can be used as a component for another apparatus as in FIG. 2, which shows a variation of apparatus 100 incorporating the functionality of apparatus 100 over separate components. In other examples the device 200 may comprise apparatus 100 as a module (shown by the optional dashed line box) for a mobile phone, PDA or audio/video player or the like. Such a module, apparatus or device may just comprise a suitably configured memory and processor.

The example apparatus/device 200 comprises a display 240 such as a Liquid Crystal Display (LCD), e-Ink, or (capacitive) touch-screen user interface. The device 200 is configured such that it may receive, include, and/or otherwise access data. For example, device 200 comprises a communications unit 250 (such as a receiver, transmitter, and/or transceiver), in communication with an antenna 260 for connection to a wireless network and/or a port (not shown). Device 200 comprises a memory 220 for storing data, which may be received via antenna 260 or user interface 230. The processor 210 may receive data from the user interface 230, from the memory 220, or from the communication unit 250. The user interface 230 may comprise one or more input units, such as, for example, a physical and/or virtual button, a touch-sensitive panel, a capacitive touch-sensitive panel, and/or one or more sensors such as infra-red sensors or surface acoustic wave sensors. Data may be output to a user of device 200 via the display device 240, and/or any other output devices provided with apparatus. The processor 210 may also store the data for later user in the memory 220. The device contains components connected via communications bus 280.

The communications unit 250 can be, for example, a receiver, transmitter, and/or transceiver, that is in communication with an antenna 260 for connecting to a wireless network (for example, to transmit a determined geographical location) and/or a port (not shown) for accepting a physical connection to a network, such that data may be received (for example, from a white space access server) via one or more types of network. The communications (or data) bus 280 may provide active coupling between the processor 210 and the memory (or storage medium) 220 to allow the processor 210 to access the computer program code stored on the memory 220.

The memory 220 comprises computer program code in the same way as the memory 120 of apparatus 100, but may also comprise other data. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

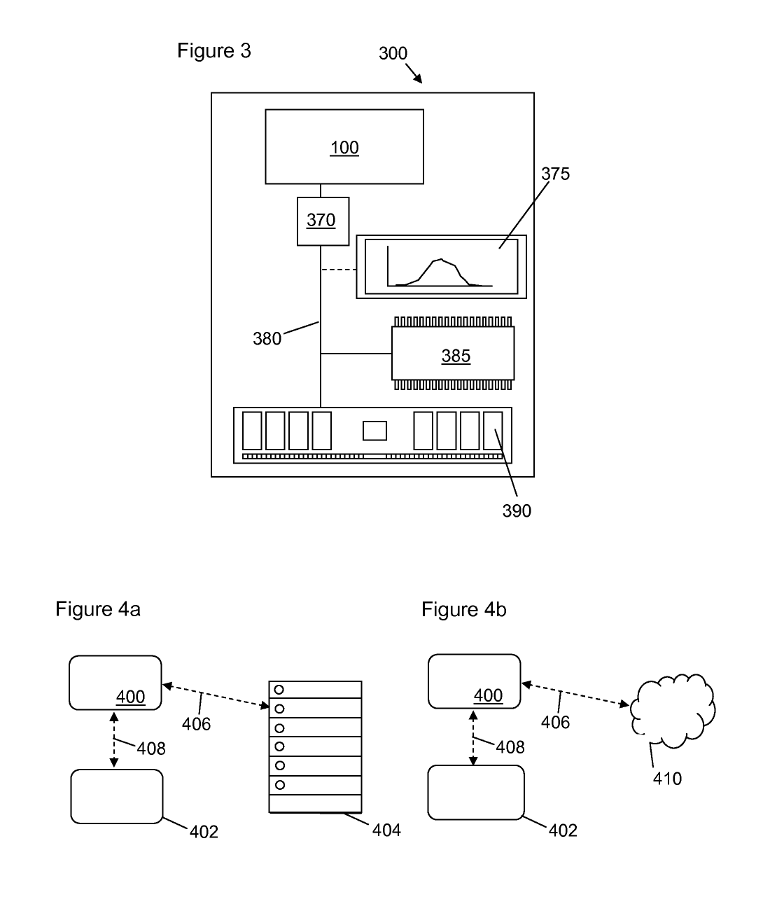

FIG. 3 shows a device/apparatus 300 which may be an electronic device, a portable electronic device, a portable telecommunications device, or a module for such a device (such as a mobile telephone, smartphone, PDA or tablet computer). The apparatus 100 may be provided as a module for a device 300, or even as a processor/memory for the device 300 or a processor/memory for a module for such a device 300. The device 300 comprises a processor 385 and a storage medium 390, which are electrically connected by a data bus 380. This data bus 380 can provide an active coupling between the processor 385 and the storage medium 390 to allow the processor 385 to access the computer program code.

The apparatus 100 in FIG. 3 is electrically connected to an input/output interface 370 that receives the output from the apparatus 100 and transmits this to the device 300 via a data bus 380. The interface 370 can be connected via the data bus 380 to a display 375 (touch-sensitive or otherwise) that provides information from the apparatus 100 to a user. Display 375 can be part of the device 300 or can be separate. The device 300 also comprises a processor 385 that is configured for general control of the apparatus 100 as well as the device 300 by providing signalling to, and receiving signalling from, other device components to manage their operation.

The storage medium 390 is configured to store computer code configured to perform, control or enable the operation of the apparatus 100. The storage medium 390 may be configured to store settings for the other device components. The processor 385 may access the storage medium 390 to retrieve the component settings in order to manage the operation of the other device components. The storage medium 390 may be a temporary storage medium such as a volatile random access memory. The storage medium 390 may also be a permanent storage medium such as a hard disk drive, a flash memory, or a non-volatile random access memory. The storage medium 390 could be composed of different combinations of the same or different memory types.

FIG. 4a illustrates an example embodiment of an apparatus according to the present disclosure in communication with a remote server. FIG. 4b shows that an example embodiment of an apparatus according to the present disclosure in communication with a “cloud” for cloud computing. In FIGS. 4a and 4b, an apparatus 400 (which may be the apparatus 100, 200, 300) is in communication 408 with, or may be in communication 408 with, another device 402. For example, an apparatus 400 may be in communication with another element of an electronic device such as a display screen, memory, processor, keyboard, mouse or a touch-screen input panel. The apparatus 400 is also shown in communication with 406 a remote computing element 404, 410.

FIG. 4a shows the remote computing element to be a remote server 404, with which the apparatus may be in wired or wireless communication (e.g., via the internet, Bluetooth, a USB connection, or any other suitable connection). In FIG. 4b, the apparatus 400 is in communication with a remote cloud 410 (which may, for example, by the Internet, or a system of remote computers configured for cloud computing). It will be appreciated that the apparatus could be in the server/cloud, e.g., as a server (or a module for the server), or distributed across the cloud. One or more functional aspects disclosed in relation to the apparatus 100, 200, 300 could be distributed across one or more servers/devices/cloud elements.

The apparatus 400 may be able to obtain/download software or an application from a remote server 404 or cloud 410 to allow the apparatus 400 to perform as described in the examples above. The remote server 404 or cloud 410 may be accessible by the apparatus 400 for the processing of the input text to take place. The input text itself may be available from a remote server 404 or cloud 410, and the apparatus may be used to communicate with the remote computing elements 404, 410 which carry out the processing and the apparatus may then obtain a route for visual display to a user. In certain examples, the apparatus may be the remote computing element(s), or a module for the same, for example if the processing is performed using distributed file system processing.

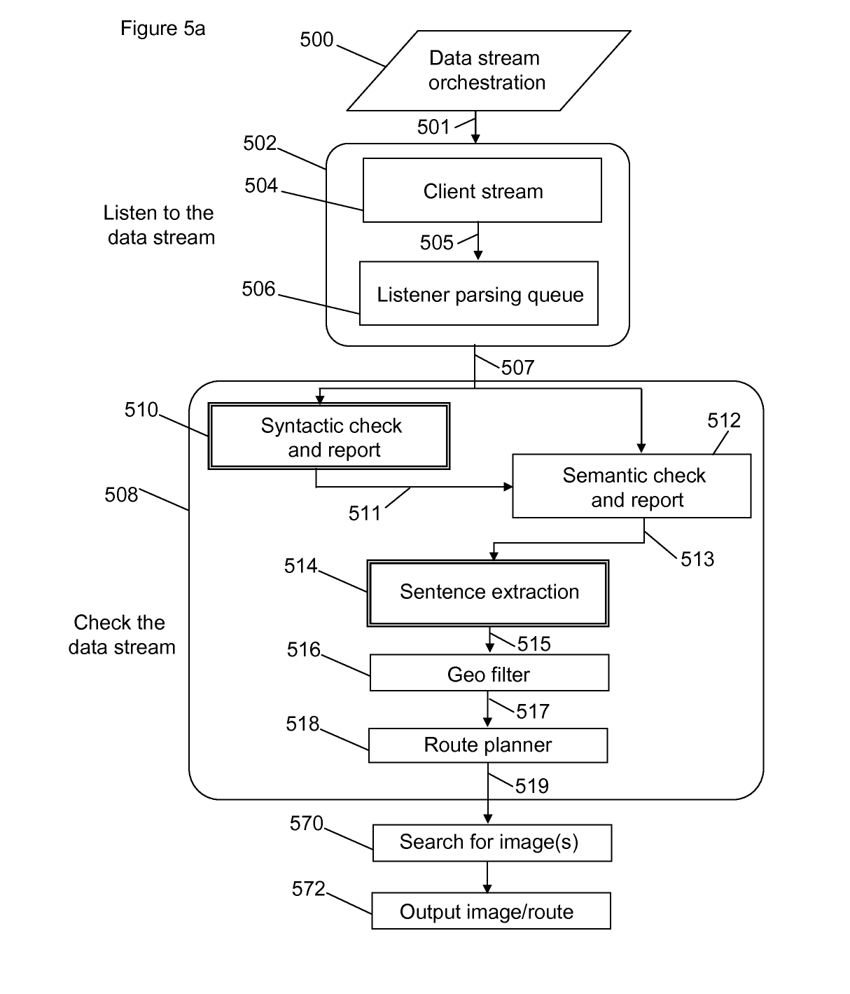

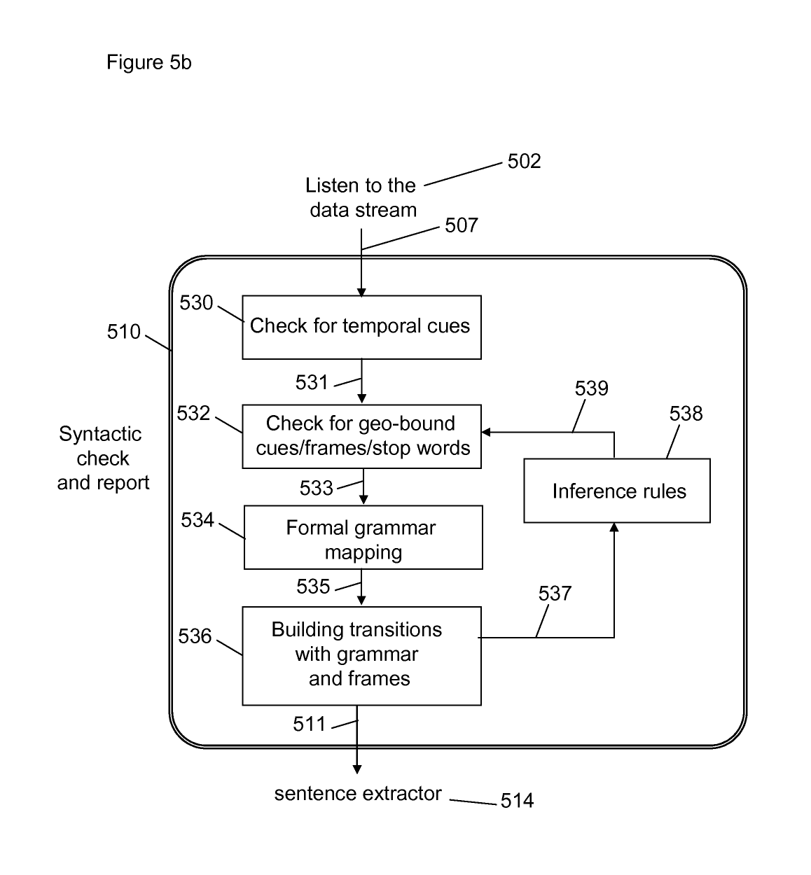

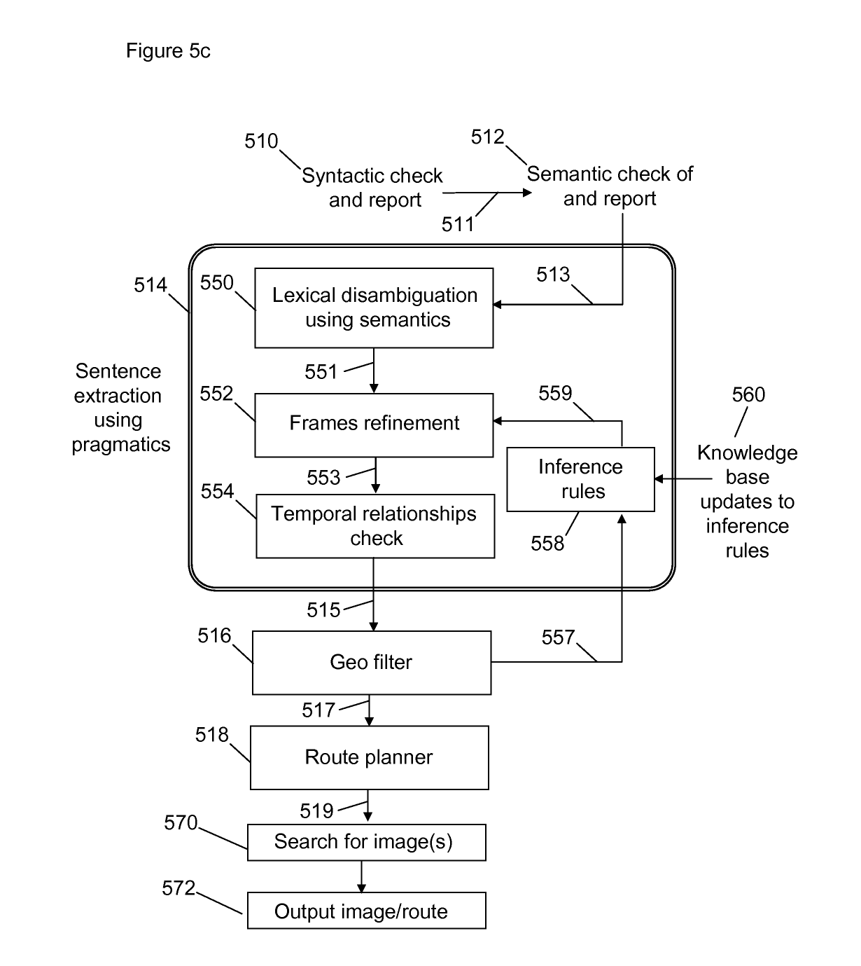

FIGS. 5a-5c illustrate a schematic flow diagram of a process of reading a portion of electronic text into an apparatus/a computer-based system, and providing a visual representation of a logical route to a user based on the description of a route in the original portion of electronic text. FIG. 5a describes stages in processing a passage of electronic text to identify at least one word associated with a geographical location in the passage of electronic text, searching for an image-based representation of the geographical location associated with the at least one identified word; and outputting the image-based representation of the geographical location to a display.

FIG. 5a illustrates the overall process from reading the portion of text into the apparatus/computer-based system, searching 570 for images relating to identified locations, and providing a route as output 572. FIG. 5b expands the step of “syntactic check and report” 510 of FIG. 5a, and FIG. 5c expands the step of “sentence extraction” 514 of FIG. 5a. The apparatus (computer-based system) may be considered to comprise a framework which performs particular processing. The framework may be considered to be a series of processing steps, comprising one or more processing elements (PEs) (e.g., processor 110, memory 120) which carry out the various steps of processing.

The process generally may be implemented using Apache Hadoop, an open-source software framework that supports data-intensive distributed applications. The Apache Hadoop “platform” may be considered to consist of the Hadoop kernel, Cascading (a framework for control and management), MapReduce (a framework for parallel problems distributed over a cluster or grid) and Hadoop Distributed File System (HDFS, which may be considered a distributed, scalable, and portable file system). Other frameworks could, of course, be used.

### Data Stream Orchestration 500

The process of creating a visual route/image-based representation of a geographical location from a portion of text begins with data stream orchestration 500. This step reformats the input text into a data stream which can be processed in the next step of listening to the data stream 502. Reformatting may be considered to mean converting a text stream to a format which is readable by the framework (i.e., may be processed in the steps which follow).

For example, any Extensible Mark-up Language (XML) based stream of text may be reformatted/transformed into a format (such as JavaScript Object Notation with Padding (JSONP)) which is understandable by the processing elements (PEs) of the framework before being fed to the PEs for processing. The data input at step 500 may be, for example, made in XML, JavaScript Object Notation (JSON) or Resource Description Framework (RDF) format, which is itself obtained from a remote source (such as an e-book) when a “GET” command is issued (e.g., “GET http://www.gutenberg.org/ebooks/12345.rdf” would retrieve the text of the e-book found at this Gutenberg web address).

The initial input text may be unbounded; that is, there are no embedded geo-tags present, nor is any particular formatting or tagging of words/phrases present in the text. An example of unbounded text is a passage from any text which contains references to locations, but in which those references are not explicitly geo-tagged or otherwise marked as special words. In contrast, an example of bounded text is an e-book text which has geo-tags explicitly specified within the text (such as, in the example text “He went to India”, the text “India” may be explicitly geo-tagged with information and/or links relating to India).

The input text may be plain text or rich text. The text may, for example, be so-called “slow moving” or “static text”, such as a part of or all of an e-book, text from a website (not updated in (near) real-time), or text from an online/electronic reference work such as an encyclopaedia (e.g., Wikipedia). The input text may also be a so-called “fast moving” or “stream” body of text such as a news feed, microblog feed (e.g., Twitter) or text from a social media page (e.g., Facebook). The data stream orchestration step 500 may be implemented to handle both “slow moving” data and “fast-moving”/“stream” data.

In the case of static data processing (i.e., the processing of “slow-moving” data, uploading the text/data to the framework may take place via cleansing and ingestion steps. In cleansing any irregularities in the text are filtered out. Once this step is done according to predefined criteria, the cleansed text is ingested, that is, the text is input into the framework for processing. In case of data stream processing (i.e., the processing of “fast-moving” data) there is no uploading as such required. The continuous data stream of unbounded data/text may be used as input. It is possible to “replay” many examples of static/slow-moving data, so that the static data stream may be processed as a “fast-moving” data stream. This may be done by generating a data stream from aggregated “slow-moving” data sets. However there may be certain limitations to this process, for example relating to the duration of the data and any data set deterioration present due to the cleansing steps.

An example of text processing according to this embodiment is provided below in relation to each processing stage. The portion of text which contains geographical locations used in the example is an extract from Jules Verne “20,000 Leagues under the Sea” (key frames and locations are underlined):
“This was in 1861, and for twelve months, or up to May, 1862, letters were regularly received from him, but no tidings whatever had come since his departure from Callao, in June, and the name of the BRITANNIA never appeared in the Shipping List.”

In this example, an example of code output 501 from the “data stream orchestration” 500 stage is:

{“stream”:“RawSentence”,
“class”:“io.s4.processor.ebook.Sentence”,“object”:
“{\“id\”:14000049,\“sentenceId\”:14000000,\“text\”:\“This was in 1861,
and for twelve months, or up to May, 1862, letters were regularly
received from him, but no tidings whatever had come since his departure
from Callao, in June, and the name of the BRITANNIA never appeared in
the Shipping List.\”,\“time\”:1242800008000}”}

This stage of processing configures the stream(s) of data/text input to the framework. For example, a selection of text which has been selected by a user or a third party service as a data source may be reconfigured by reformatting the text, if necessary, and feeding it to the framework as input.

### Listen to the Data Stream 502

The data stream 501 from the data stream orchestration step 500 is processed so that it is “listened to” 502. This includes a client stream step 504 and a listener parsing queue 506 step. The client stream step 504 is the entry point for the stream processing, and can perform a handshake with any data source. Stream processing refers to the processing of (near) real-time text input. The handshaking step ensures that different text formats may be used by the apparatus. Thus text input 501 from many different sources and in many different formats may be received at the client stream step 504 and used for input. The streams are generally processed/“understood” by using arbitrary source semantics based on already-established semantics, or by using semantics external to the system knowledge (pragmatics).

The output 505 from the client stream step 504 is passed to the listener parsing queue step 506, which receives the formatted data from the client stream step 504, and transforms it into a stream-processing-understandable format for the rest of the process. This step may be considered to prepare the input text for processing/action, for harmonisation and in certain examples, unification (that is, unification of the formatting with that required by the framework/PEs. In this way, both “slow moving” data and “fast moving”/“stream” data may both be handled in the same way. It will be appreciated that in embodiments without a specific route planner 518, block 518 would be considered to be a provider of an image-based representation (or representations) of the identified geographical location(s), such as a photograph or image of a particular identified/extracted geographical location.

In the Jules Verne text example, an example of code output 507 from the “listen to the data stream” step 502 is:

{“stream”:“RawSentence”,
“class”:“io.s4.processor.ebook.Sentence”,“object”:
“{\“id\”:14000049,\“sentenceId\”:14000000,\“text\”:\“This was in 1861,
and for twelve months, or up to May, 1862, letters were regularly
received from him, but no tidings whatever had come since his departure
from Callao, in June, and the name of the BRITANNIA never appeared in
the Shipping List.\”,\“time\”:1242800008000}”}

It will be appreciated that the code output from the data orchestration section 500 and the listen to data stream section 502 is the same. This is because it is rendered from initially used JSONP (JSON with padding, JavaScript Object Notation) stream and this is behind 500. Since 502 listens to what 500 is sending (in this case we have REST API, and 500 advertises the data via certain URL/stream.json), (502) gets the data in necessary format (JSONP) but should make JSON out of it. Since the difference is only in data stream wrapper (jsoncallback in case of JSONP) the other part remains exactly the same (clean JSON). So does our code example. There are cases when source data stream can be other than JSON, then 500 and 502 will do extra work. Then, (500) reformats it from (for ex.) pure XML into JSON stream and (502) takes it in regular chunks into the system.

The output text 507 is then processed in a “check the data stream” step 508 in which many of the processing steps for identifying geographical locations, and logical sentence structures such that a route may be determined are performed. This step 508 identifies the frames/segments within the text. The “check the data stream” step 508 in this example contains the following stages:
syntactic check and report 510 (a verification of correct placement of segments and frames);
semantic check and report 512 (a check of the structures initially identified/drafted based on cues);
sentence extraction 514 using pragmatics (which uses previously detected structures in the event vector to draft sentences containing geo-bound facts);
geo-filter 516 (to check for the detected geographically bound frames and cues); and
   route planner 518 (the actual route creator, so the resultant data set allows the route to be constructed with all necessary meta-data, such as links to e.g., photos, video, or any other suitable data types).

The sentence/text is checked for temporal events in order to determine the event vector. An event vector may contain a series of information, such as a location, a time, and a person. For example, event=(location; time; person) is an event vector. Therefore, a location may be associated with a particular time at which the location was visited, and with a person, such as the narrator in a story who is describing the location. Using an event vector, later segments of text may be evaluated against known frames/structures. That is to say, a location which is associated with a person (from a portion of text stating “Harry went to New York . . . ”), may be checked to determine if it logical to associate that same location (New York) with the same person (Harry) if the location of New York appears later in the text.

The event vector may be monitored with time. Using an event vector, a resultant route can be constructed after identification and disambiguation of all the segments of the sentence/text. After detection of the temporal events (e.g., “up to May, 1862”) the sentence is broken into two pieces, to give segments relating to before and after the occurrence of the identified temporal event. In each segment, temporal cues are searched for in order to correct the event vector if necessary, to determine what happened and when it happened.

### Check the Data Stream 508

At this stage the text 507 has been processed so that, regardless of the initial format or whether it was “slow-moving” or “fast-moving”/“stream” data, it may be processed in the step of checking the data stream 508. The text 507 is processed both syntactically 510 and semantically 512 in separate steps. In some examples, parameterized packets are transferred to the sentence extraction step 514 from the syntactic check step 510.

A syntactic check 510 of the input data 507 verifies the correct placement of segments and frames in the text 507. A segment, or frame, is a portion of the text which may be considered a logical unit, such as a word or phrase. A frame may be considered a templated segment, in that there is short-term understanding within the frame (e.g., “he went to London”), and semantics are present in the frame to logically link/place the frame within the surrounding text/description. This process of understanding a frame within the surrounding text provides knowledge (i.e., understanding of what the frame means). Syntactic checking may be considered a type of parsing, to determine the grammatical structure of the text with respect to a known grammatical structure. Syntactic checking 510 is discussed in more detail with reference to FIG. 5b.

A semantic check 512 performed on the input data 507 may be considered a check of the structures which are indicated by cues, in order to obtain a meaning for the portion of text. A cue may be considered to be a particular word which provides a logical cue to a reader to begin a logical portion of text. A cue word may also be considered a connective expression which links two segments of text, in particular signifying a change in the text from one segment to another. Thus, cue words such as “thus” or “therefore” may indicate a consequence, and cue words such as “meanwhile”, “on the other hand” or “elsewhere” may indicate that an event is about to be described which is different to the event just discussed. By checking the semantics of the text 507, the logical structure (semantics) and meaning of the text may be obtained.

The results 511, 513 of the syntactic check 510 and the semantic check 512 are input to a sentence extraction stage 514. This is discussed in more detail in relation to FIG. 5c, and relates to extracting sentences using pragmatics. Pragmatics may be considered to involve a link from a piece of text/segment to any previously established knowledge, so that is can be assumed that the meaning of a particular segment is established. If the meaning of a segment can be established, then the segment may be considered a frame, as it can be understood as a stand-alone section of text.

In other words, this sentence extraction stage 514 uses previously detected structures to identify sentences and phrases containing geo-bound facts (i.e., words and phrases determined to be geographical locations, directions, and time cues, for example). The output 515 from the sentence extraction stage 515 includes the identified geographical locations marked-up as such. The marked-up geographical locations may be considered geographically bound, or geo-bound, cues

### Geo-Filter 516

The geo-filter step 516 takes the text with geographical locations identified 515 as input, and checks for the geographically bound cues to filter out the identified geographical information in the text, including the context of the cues so that they may be processed in a logical manner compared with the original text. The geo-filtering is based on a geo-search (itself based on fuzzy logic) and on geo-coding (in which, given a piece of text, the latitude and longitude of a location, and a radius/bounding box around a location can be determined). At this stage, the event vector is “relaxed” to detect any misalignments with the syntactic and semantic checks. In some examples, the geo-filter step takes priority, and thus the context of the identified location can be stretched along the bounding box based on the geo-filter step.

In the Jules Verne text example, an example of code output 517 from the geo filter step 516 is:

{″geodata″:″Nodes″, ″class″:″io.s4.processor.routing.GeoFilter″,
″object″:″{\″id\″:24000088,\″frameId\″:14000010,\″text\″:\″May,
1862”,\″time\″:1242811522010,\″location\″:\Callao}″},
″object″:″{\″id\″:24000090,\″frameId\″:14000020,\″text\″:\″departure
from Callao”,\″time\″:1242811522015,\″location\″:\Callao}″},
″object″:″{\″id\″:24000092,\″frameId\″:14000030,\″text\″:\″in
June”,\″time\″:1242811522019,\″location\″:\Callao}″}}

The frames “May 1862”, “departure from Callao”, and “in June” are identified to place the location of Callao in context and formally tag the word “Callao” as a location (“location\”:\callao}).

The geo-filter uses a geo-coder or reverse geo-coder to correct the event vector according to an assumed text-based location (such as a city name, place name, landmark name, etc.) Therefore, after this stage, identified time points and identified geo-points (locations) can be used as nodes in the route-planning stage 518.

### Route Planner 518

The route planner step 518 takes the geo-filtered text 517 as input and creates the route. The geographically bound cues, in context, are identified so that a route may be determined based on the geographically bound cues. The resulting data set 519 allows the construction of a route which identifies the locations in the original text, and also identifies the context in which the locations are discussed, so that logical route information 519 may be obtained and used to create a visual representation of a route for a user. The locations in the constructed route may be linked to photographs, videos, street-level map views and/or satellite views, for example so that the route described in the original text may be visually presented to a user as a logical series of images and videos corresponding to the route described in the original text.

In the Jules Verne text example, an example of code output 519 from the route planner step 518 is:

{″route″:″Raw″, ″class″:″io.s4.processor.routing.RGC″,
″object″:″{\″id\″:34000090,\″routeId\″:14000020,\″text\″:\″staying”,\″ti
me\″:05.1862”,\″location\″:\Callao}″},
″object″:″{\″id\″:34000092,\″routeId\″:14000030,\″text\″:\″departure”,\″
time\″:06.1862,\″location\″:\Callao}″}}

The location Callao is formally identified (“location\”:\Callao}”), as is the year “1862” and a route identifier is created to tag the location “Callao” with the year “1862”. The actions of the character are also obtained; that he stayed in Callao in May 1862 (05.1862) and he departed from Callao in June 1862 (06.1862).

The possible route candidates identified (as many as can possibly be identified) are identified in this step 518. The route planner step 518 takes all these candidates and analyses them spatially and temporally, producing one route or several routes which have open meta-tags for any external data to be associated with the routes. Such meta-tags may link to photos, videos, or other artefacts (structured or unstructured, for example). The possible routes identified can be output as image-based representations of the geographical locations to a display, for example for a user to view the route.

The output 519 from the route planner is used to search 570 for an image-based representation, or representations, of the geographical location(s) associated with the word(s) relating to location identified in the text. The search identifies one or more image-based representations of a geographical location or locations identified in the text. The images (which may be photographs, movies, street-level views, realistic and/or schematic maps) are output at step 572 to a display, for example for a user to view.

FIG. 5b expands the steps involved in the syntactic check 510 of FIG. 5a.

### Temporal Cues 530

In the first stage of the syntactic check, the input from the listened-to data stream 507 is checked for temporal cues 530. The text is checked for events, in order to draft the “event vector”.

In the Jules Verne text example, an example of code output 531 from the check for temporal cues step 530 is:

{“stream”:“RawSentence”, “class”:“io.s4.processor.cues.Sentence”,
“object”:“{\“id\”:24000086,\“cueId\”:12000000,\“text\”:\NULL,\“time\”:12
42801726000,\“location\”:\NULL}”}}

In this example there are no temporal cues, such as “meanwhile” or “then”, identified in the text in this example. Temporal cues can be useful for natural language expressiveness, and thus can also be useful for logical segmentation of the text. If any temporal cues are identified, then the text can be easier to digitize (split up). If no temporal cues are identified, then temporal or spatial transitions may be searched for. Therefore, temporal cues in the sentence text are searched for as a patterned construction lookup (that is, potential temporal cues, temporal transitions and spatial transitions can be identified and compared with known terms in a look-up table/database for example).

When block 518 is not a route planner per se, it may be a provider of an image-based representation (or representations) of the identified geographical location(s). For example it may provide a photograph or image of a particular identified/extracted geographical location associated with the identified text. The image-based representation(s) can be output to a display, for example so a user can browse images, maps and information websites of the identified locations.

### Check for Geo-Bound Cues/Frames/Stop Words 532

The output text 531 from the temporal cue check 530 is input to a check for frames step 532. A frame may be considered a section of text which can be treated as a logical unit, such as a short phrase (e.g., “in the end”) or a date (e.g., May 1940). The check for frames step 532 checks the text for cue words and stop words, such as “then . . . ” (a cue word) or “in June” (a stop word causing an end to a logical frame/section of text). It also checks known structures bound by cues by, for example, comparing the identified frames in the text with known frames stored in a database/look-up table.

By performing the check against known frames, the least meaningful segments identified by the check for frames step 532 may be accorded less weight in the processing of the text as a whole. For example, when comparing an identified frame with a possible frame identified later in the text, if the initially identified frame is accorded a lower weight, it may be provided as a comparison after comparing the later identified frame with a standard frame from the database. This weighting allows the text processing to take place while minimising the risk of using erroneous identified frames as a standard for later identification of other frames in the text.

In the Jules Verne text example, an example of code output 533 from the check for frames step 532 is:

{″stream″:″RawSentence″, ″class″:″io.s4.processor.frames.Sentence″,
″object″:″{\″id\″:24000088,\″frameId\″:14000010,\″text\″:\″May,
1862”,\″time\″:1242811522010,\″location\″:\NULL}″},
″object″:″{\″id\″:24000090,\″frameId\″:14000020,\″text\″:\″departure
from Callao”,\″time\″:1242811522015,\″location\″:\NULL}″},
″object″:″{\″id\″:24000092,\″frameId\″:14000030,\″text\″:\″in
June”,\″time\″:1242811522019,\″location\″:\NULL}″}}

The frames “May 1862”, “departure from Callao”, “in June” are identified. The seeding grammar and identified first segments are checked, and possible frames are checked. As described above, any known segments (temporal or spatial transitions) are searched for in a look-up table/database to be identified/matched against earlier established knowledge (look-up table entries). In certain cases, a simple sentence may be constructed from just one meaningful segment. The next stage is a formal (established) grammar check/mapping 534.

### Formal Grammar Mapping 534

The output 533 from the check for frames step 532 is input to a step of formal grammar mapping 534. This step checks the formal structure/frames identified in previous steps with newly identified frames to ensure that the grammar in the text is consistently interpreted.

In the Jules Verne text example, an example of code output 535 from the formal grammar mapping step 534 is:

{″stream″:″RawSentence″, ″class″:″io.s4.processor.map.Sentence″,
″object″:″{\″id\″:54000000,\″mapId\″:27000000,\″map\″:\″This was in
1861”,\″time\″:1242813521000,\″location\″:\NULL}″},
″object″:″{\″id\″:24000094,\″mapId\″:27000040,\″map\″:\″twelve
months”,\″time\″:1242814523110,\″location\″:\NULL}″}}

The initially assumed segmentation of the text is compared with established grammar, and a check is therefore performed to validate whether the assumptions as to segmentation were correct. If not, this is detected during the following transition check (building transitions with grammar and frames) 536. The frames “This was in 1861” and “twelve months” are identified as formal structures in the text which give logical meaning to the identified geo-bound cues, frames and stop words identified at step 532.

Building Transitions with Grammar and Frames 536

The output 535 from the formal grammar mapping step 534 is input to a step of building transitions with grammar and frames 536. This step revises the frames (identified in the check for frames step 532) and the event vector (identified in the temporal cues step 530) and cleans up the text, reconstructing the frames and event vector. The text is cleaned up by stop words and cues being excluded from the frames, and being stored separately as individual objects in the event vectors. Checks are performed to determine which frames are related and what any different identified frames and event vector relate to. The output 511 from the building transitions step 536 is used as input for the sentence extractor step 514 shown in FIG. 5c.

In the Jules Verne text example, an example of code output 511 from the building transitions step 536 is:

{″stream″:″RawSentence″, ″class″:″io.s4.processor.transitions.Sentence″,
″object″:″{\″id\″:24000086,\″frameId\″:14000000,\″text\″:\″This was in
1861”,\″time\″:1242811522000,\″location\″:\NULL}″},
″object″:″{\″id\″:24000094,\″frameId\″:14000040,\″text\″:\″twelve
months”,\″time\″:1242811522020,\″location\″:\NULL}″},
″object″:″{\″id\″:24000088,\″frameId\″:14000010,\″text\″:\″May,
1862”,\″time\″:1242811522010,\″location\″:\NULL}″},
″object″:″{\″id\″:24000090,\″frameId\″:14000020,\″text\″:\″departure
from Callao”,\″time\″:1242811522015,\″location\″:\NULL}″},
″object″:″{\″id\″:24000092,\″frameId\″:14000030,\″text\″:\″in
June”,\″time\″:1242811522019,\″location\″:\NULL}″}}

In this stage, the identified objects are stretched along the event vector for the first time. That is, the assumed event vector is used and the identified objects (e.g., locations, times) are entered into the event vector. The frames “This was in 1861” “twelve months” “May 1862”, “departure from Callao” and “in June” are identified, and the temporal cues are put into context using the identified geo-bound cues, frames and stop words and the earlier assumed event vector.

### Inference Rules 538

A feedback loop is used between the building transitions step 536 and the check for frames step 532. The output 537 from the building transitions step 536 is passed to an inference rules step 538. At this step 538, rules are used to establish newly detected semantics or syntactic features, or to update already detected/elaborated semantics or syntactic features and feed back 539 to the check for frames step 532. The purpose is generally to improve the accuracy and scope of identification of frames in the text and aid the computer based system to “learn” how to interpret the text input.

In the Jules Verne text example, an example of code input 537 to the inference rules step 538 is:

{″rules″:″Transition″, ″class″:″io.s4.processor.inference.Rules″,
″object″:″{\″id\″:73000006,\″ruleId\″:39000000,\″rule\″:\″
is_occupied_by”,\″time\″:1242811522000,\″type\″:\check-insert}″},
″object″:″{\″id\″:7300007,\″ruleId\″:39000040,\″rule\″:\″is_related_to”,
\″time\″:1242811522020,\″type\″:\check-insert}″}}

Typically there may be two types of a rule to infer. Either a segment is taken to relate to spatial use (a check if performed if a segment is “occupied by” a location) or a segment is taken to relate to a temporal use (a check is performed if a segment is “related to” a time indication. If there is a mismatch in terms of rule performance then the mismatch is collected, noted, and once progress is made in disambiguating the segment, the rules are updated. A first update can be triggered by the transitions check 536 (for example, relating to grammar). A second update can be triggered by the geo-filter check 516 (such as event vector misalignment).

An example of code output 539 from the inference rules step 538 is:

{″rules″:″Frames″, ″class″:″io.s4.processor.inference.Rules″,
″object″:″{\″id\″:73000008,\″ruleId\″:40000000,\″rule\″:\″
is_occupied_by”,\″time\″:1242811522000,\″type\″:\check-update}″},
″object″:″{\″id\″:7300009,\″ruleId\″:40000010,\″rule\″:\″
is_related_to”,\″time\″:1242811522020,\″type\″:\check-update}″}}

Two exemplary types of rule are taken as described above, “is_occupied_by” for locations, and “is_related_to” for temporal indications. The results are fed back so the framework can “learn” about the text being processed and can update the rules for understanding the text. The above code performs a “check, if not valid, update rules” step.

FIG. 5c expands the steps involved in the sentence extraction 514 of FIG. 5a.

The output 511 from the building transitions step 511 of the syntactic check and report step 510 is input to the sentence extractor along with the output 513 from the semantic check step 512. In some examples, parameterized packets are transferred to the sentence extraction step 514 from the syntactic check step 510 (not shown), but FIG. 5c shows a “waterfall connection” from the syntactic check 510 to the semantic check 512 onto the sentence extraction 514 for clarity.

As noted above, in the Jules Verne text example, an example of code output 511 from the syntactic check and report step 510 (from the building transitions step 536 within the syntactic check and report step 510) is:

{″stream″:″RawSentence″, ″class″:″io.s4.processor.transitions.Sentence″,
″object″:″{\″id\″:24000086,\″frameId\″:14000000,\″text\″:\″This was in
1861”,\″time\″:1242811522000,\″location\″:\NULL}″},
″object″:″{\″id\″:24000094,\″frameId\″:14000040,\″text\″:\″twelve
months”,\″time\″:1242811522020,\″location\″:\NULL}″},
″object″:″{\″id\″:24000088,\″frameId\″:14000010,\″text\″:\″May,
1862”,\″time\″:1242811522010,\″location\″:\NULL}″},
″object″:″{\″id\″:24000090,\″frameId\″:14000020,\″text\″:\″departure
from Callao”,\″time\″:1242811522015,\″location\″:\NULL}″},
″object″:″{\″id\″:24000092,\″frameId\″:14000030,\″text\″:\″in
June”,\″time\″:1242811522019,\″location\″:\NULL}″}}

The frames “This was in 1861” “twelve months” “May 1862”, “departure from Callao” and “in June” are identified. The structure is validated and confirmed in that the previously identified frames are the correct ones. These frames may be used further in checks of the event vector. Further, an example of code input 513 to the sentence extractor 514 from the semantic check and report step 512 is:

{“http:\/\/map-
platforms.ntc.nokia.com\/places\/schema.json”:{“http:\/\/www.w3.org\/199
9\/02\/22-rdf-syntax-
ns#type”:[{“type”:“uri”,“value”:“http:\/\/xmlns.com\/foaf\/0.1\/Document
”},

This portion of code 513 asks for an external source in order to update/bootstrap the ontology for the particular domain. The presented query asks a backend server, in this example “map-platforms.ntc.nokia.com”, for an ontology list. Once the ontology list is returned a selection of the correct frame can be made according to the semantics drafted/identified during the semantics analysis 512.

### Lexical Disambiguation Using Semantics 550

The first step in sentence extraction 514 is lexical disambiguation using semantics 550. At this step, if there are any uncertainties in the detected frames or segments in the text, these are addressed and ambiguities are minimised. This may be done by using known semantics (ontology or schema), such that different words can be mapped to an identified word in the text even if the different words have the same meaning. This may be done via ontology mapping.

In the Jules Verne text example, an example of code output 551 from the lexical disambiguation using semantics step 550 is:

{″stream″:″RawSentence″, ″class″:″io.s4.processor.frames.Sentence″,
″object″:″{\″id\″:24000088,\″frameId\″:14000010,\″text\″:\″May,
1862”,\″time\″:1242811522010,\″location\″:\NULL}″},
″object″:″{\″id\″:24000090,\″frameId\″:14000020,\″text\″:\″departure
from Callao”,\″time\″:1242811522015,\″location\″:\NULL}″},
″object″:″{\″id\″:24000092,\″frameId\″:14000030,\″text\″:\″in
June”,\″time\″:1242811522019,\″location\″:\NULL}″}}

The frames “May 1862”, “departure from Callao”, and “in June” are identified and any ambiguities are addressed using ontology mapping as described above. Ontology is used to validate the frames against known structures in the ontology data base, in order to minimise misinterpretation.

### Frames Refinement 552

The output 551 of the lexical disambiguation step 550 provides input to the frames refinement step 552. Here a similar process takes place as at the check for frames step 532 earlier, but using the output 551 from the lexical disambiguation step 550 as the input text.

In the Jules Verne text example, an example of code output 553 from the frames refinement step 552 is:

{″stream″:″RawSentence″, ″class″:″io.s4.processor.transitions.Sentence″,
″object″:″{\″id\″:24000086,\″frameId\″:14000000,\″text\″:\″This was in
1861”,\″time\″:1242811522000,\″location\″:\NULL}″},
″object″:″{\″id\″:24000094,\″frameId\″:14000040,\″text\″:\″twelve
months”,\″time\″:1242811522020,\″location\″:\NULL}″},
″object″:″{\″id\″:24000088,\″frameId\″:14000010,\″text\″:\″May,
1862”,\″time\″:1242811522010,\″location\″:\NULL}″},
″object″:″{\″id\″:24000090,\″frameId\″:14000020,\″text\″:\″departure
from Callao”,\″time\″:1242811522015,\″location\″:\NULL}″},
″object″:″{\″id\″:24000092,\″frameId\″:14000030,\″text\″:\″in
June”,\″time\″:1242811522019,\″location\″:\NULL}″}}

If a frame has been updated during the processing of the text, for example because of newly detected pragmatics, the frames (which are already identified) are refined. The frames “This was in 1861” “twelve months” “May 1862”, “departure from Callao” and “in June” are checked and any refinements to the structures made. This is done by, after the spatial relationships being identified (for example, a particular village is determined to be in a particular country, or a person is determined to be travelling to a city in a particular direction), then an assumption can be generated as to the associated time/date and spatial relationships. Temporal validation may be performed again at this stage in case of the potential impact of the geo-filtering process 516.

### Temporal Relationships Check 554

The output 553 of the frames refinement step 552 provides input to the temporal relationships check 554. At this step 554, the events vector is reconstructed from the detected cues, frames and segments identified in previous steps. The output 515 of the temporal relationships check 554 includes the identified geographical locations marked-up as such (geographically bound cues) and is provided to the geo-filter step 517.

In the Jules Verne text example, an example of code output 515 from the temporal relationships check 554 is:

{″stream″:″RawSentence″, ″class″:″io.s4.processor.transitions.Sentence″,
″object″:″{\″id\″:24000088,\″frameId\″:14000010,\″text\″:\″May,
1862”,\″time\″:1242811522010,\″location\″:\Callao}″},
″object″:″{\″id\″:24000090,\″frameId\″:14000020,\″text\″:\″departure
from Callao”,\″time\″:1242811522015,\″location\″:\Callao}″},
″object″:″{\″id\″:24000092,\″frameId\″:14000030,\″text\″:\″in
June”,\″time\″:1242811522019,\″location\″:\Callao}″}}

At this step, the time dependency is checked. If one segment/frame depends time-wise from any other frame/segment, then a temporal transition between the two frames/segments can be constructed using this fact. The frames “May 1862”, “departure from Callao”, and “in June” are checked as being appropriate temporal cues. At this stage the location is formally identified as “Callao” and the other identified text provides context for that location, such as the year (1861/1862), a length of time (twelve months), an action (departure from Callao), and a month (May/June).

### Inference Rules 558

A second inference rules 558 feedback loop is used between the geo filter step 516 and frames refinement step 552 in a similar way to the earlier inference rules 538 feedback loop. The output 557 from the geo filter step 516 is passed to the second inference rules step 558, at which point rules are used to establish any newly detected semantics or syntactic features, or to update already detected/elaborated semantics or syntactic features and feed back 559 to the frames refinement step 552. Again this step is aimed to generally improve the accuracy and scope of identification of frames in the text and aid the computer based system to “learn” how to interpret the text input.

In the Jules Verne text example, an example of code input 557 to the inference rules step 558 is:

{″rules″:″Transition″, ″class″:″io.s4.processor.inference.Rules″,
″object″:″{\″id\″:93000006,\″ruleId\″:39000000,\″rule\″:\″
is_occupied_by”,\″time\″:1243921515000,\″type\″:\check-insert}″},
″object″:″{\″id\″:9300007,\″ruleId\″:39000040,\″rule\″:\″is_related_to”,
\″time\″:1243932410120,\″type\″:\check-insert}″}}

and an example of code output 559 from the inference rules step 558 is:

{″rules″:″Frames″, ″class″:″io.s4.processor.inference.Rules″,
″object″:″{\″id\″:93000008,\″ruleId\″:40000000,\″rule\″:\″
is_occupied_by”,\″time\″:1244711511000,\″type\″:\check-update}″},
″object″:″{\″id\″:9300009,\″ruleId\″:40000010,\″rule\″:\″
is_related_to”,\″time\″:1244811523010,\″type\″:\check-update}″}}

This stage performs the same way as discussed in relation to the previous inference rules loop 537, 538, 539, but on a differently processed data set (as this loop occurs later in the overall processing).

Thus overall, any body of text may be used as input, whether a static, slow-moving piece of text such as an e-book, or a fast-moving/stream of text such as a news feed. The text is checked to identify temporal relationships (for example, at the check for temporal cues 530 during syntactic check 510 and the temporal relationships check 554 during sentence extraction 514). The text is also checked to identify frames within the text (for example, at the check for geo-bound cues/frames/stop words step 532 during syntactic checking 510, and the frames refinement 552 during sentence extraction 514). Thus the apparatus is configured to process a passage of electronic text to identify at least one word associated with a geographical location in the passage of electronic text.

The specific geo filter step 516 identifies the geographical locations in the text in their particular logical contents, in order for a logical route to be determined as described in the input text.

Therefore, a user may take any portion/piece of text and the apparatus may be configured to identify a logical route described in the text by identifying locations and the context in which they are discussed. The route is then presented to a user in a visual way, for example as locations/routes on a map or by a moving route through a street-level view visual representation. The apparatus thus searches 570 for image-based representations of geographical locations associated with the identified word(s), and outputs 572 the image-based representation(s) of the geographical location to a display.

The above mentioned description has processed a passage of electronic text which is in English language. It will be appreciated that English has only been used as an example and that the method can be applied to other languages which use alphabets or even characters/symbols. Thus, any alphabet (Latin/Cyrillic-based, KR and JP) can be processed in the same manner. In the case of symbols based languages (e.g. CN) some slight variations based on the structure of the language may be required, but with the main building blocks discussed above operating in the same way. Accordingly, the principles described can be applied to Logographic (e.g. Chinese), Logophonetic, Syllabic, Consonantal Alphabet, Syllabic Alphabet, Segmental Alphabet, pictographic script, ideographic script, analytic transitional script, phonetic script (e.g Korean hangul), or alphabetic script types of writing systems.

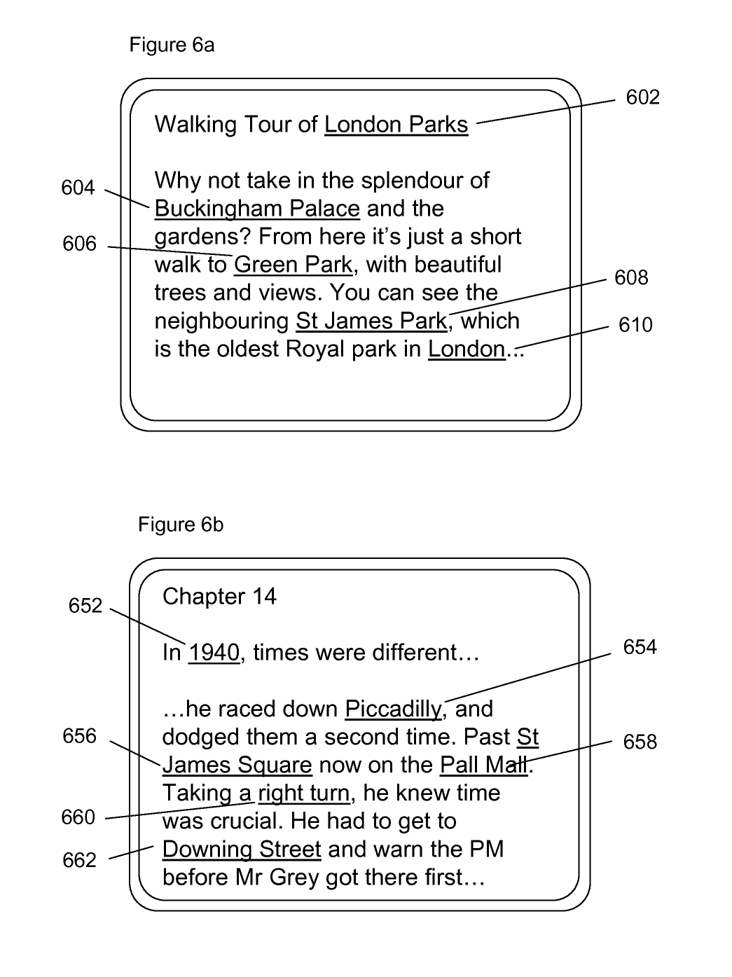

FIGS. 6a and 6b illustrate other examples in which two pieces of text have been processed according to particular embodiments.

FIG. 6a shows a piece of text loaded onto/available to an apparatus which is a portable electronic device, such as a smartphone, e-book or tablet computer. The text describes a portion of a walking tour of London Parks. The structure “London Parks” 602 in the title of the text has been identified as a location which may be used to give context to the locations identified in the body of the electronic text. The locations “Buckingham Palace” 604, “Green Park” 606 and “St James Park” 608 have all been identified as locations. The location “London” 610 has also been identified in the text. The terms “London” 610 and “London Parks” 602 may be considered to provide a semantic framework for the other identified locations 604, 606, 608 so that the other locations are identified and treated in the context of being London Parks. The route planner 518 may identify the locations 604, 606, 608 on a map for a user to view. Since the context of “London Parks” has been identified, the apparatus may be able to identify that each of the locations 604, 606, 608 is a park, in London. Thus the “Buckingham Palace” 604 location may be identified as the Buckingham Palace Gardens, rather than the actual Palace building, and the location of the gardens may be identified on a map rather than the location of the Palace itself.

FIG. 6b shows another piece of electronic text loaded onto an apparatus which may be a portable electronic device. The text describes a portion of an action scene in a historical drama novel. The apparatus has identified a time cue “1940” 652, four geographical locations: “Piccadilly” 654; “St James Square” 656; “Pall Mall” 658; and “Downing Street” 662, and has identified the phrase/frame “right turn” 660. The apparatus is able to identify locations on a map corresponding to the locations identified 654, 656, 658, 662 in the text. Further, the apparatus is able to use the identified time cue, “1940” 652, for example to provide a map in a style illustrating the 1940's era (for example, in black and white, or a “war-time” style map, or even on a map from the 1940s era rather than a modern map). Further, the apparatus may be able to identify the frame “right turn” 660, and be able to also identify the frame “right turn” 660 between the locations “Pall Mall” 658 and “Downing Street” 662, the apparatus is able to not only plot the identified locations on a map, but also generate a route from the locations starting from Piccadilly, to St James Square on the Pall Mall, then a right turn, and to Downing Street. The identified frames “1940” and “right turn” provide a semantic framework for the identified locations so that a logical route between the locations may be generated on a map (or in other examples, on a street-level view visual representation of the route).

It will be appreciated that interconnecting geographical locations between two mentioned points may be searched and identified in certain examples. Thus, images of locations which are not necessarily explicitly identified in the text but would be, for example, points of interest or other marking locations (e.g. where turns are made or junctions) on the route between the two explicitly mentioned locations are also shown.

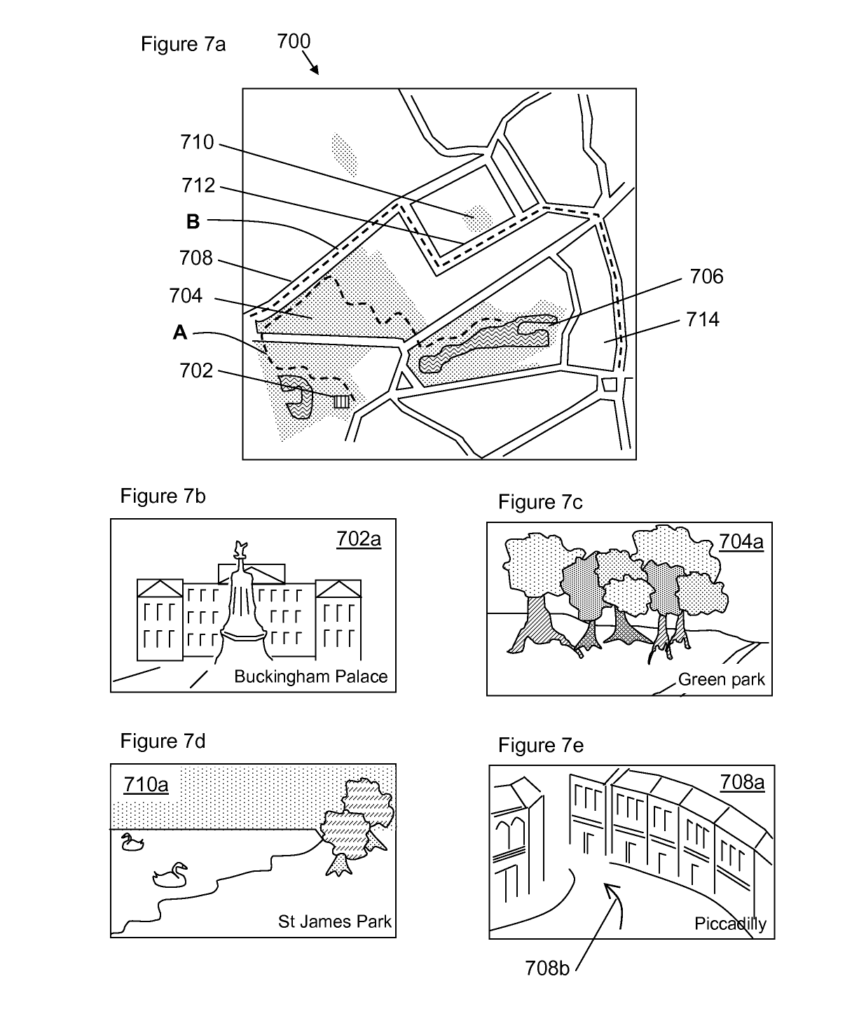

FIG. 7a illustrates a map 700 on which the two routes identified from the texts of FIGS. 7a and 7b is shown. According to the identified route from the text of FIG. 7a, through London Parks, the identified locations of Buckingham Palace gardens 702, Green Park 704, and St James Park 706 are shown along route A. FIGS. 7b, 7c and 7d illustrate photographs of Buckingham Palace 702a, Green Park 704a, and St James Park 710a which may be provided for display to a user. The photographs 702a, 704a, 710a have been identified based on the identified geographical location frames in the text. Thus the user is able to obtain a visual representation (a map showing a route, and/or photographs), corresponding to the text shown in FIG. 6a. This map can be used to allow a user to navigate whilst travelling at the location (e.g., by use of GPS or other location technology) but this need not be the case. The apparatus has searched for an image-based representation of the geographical locations associated with the identified location words, and can output an image-based representation of the geographical locations to a display.

FIG. 7a also illustrates a route identified from the text of FIG. 6b according to the identified geographical locations and frames. According to the route identified from the text of FIG. 6b, route B is shown passing along Piccadilly 708, past St James Square 710 on Pall Mall 712, taking a right turn to go to Downing Street 714.

FIG. 7e shows a screenshot from a street-level view along which the user can take a “virtual tour” and, for example, move along a street-level view of Piccadilly 708a, and onto the rest of the route if they wish. The arrow 708a indicates that the user may, for example, click on the street-view shown and move forward along the Piccadilly road, to effectively follow the route taken by the character in the story shown in FIG. 6b.

Since the cue “1940” was identified in the text, the street-level view may be presented to the user according to the view which a person would have had in 1940. This may be re-created by a series of photographs dating from 1940, for example. The map 700 may similarly be rendered in the style of a map from the 1940s based on the detection of the temporal cue “1940” in the text.

Once the routes A and B shown on FIG. 7a have been generated from the processed texts, they may, in some examples, be stored for later viewing by the user. Thus the apparatus need not process the piece of text each time in order to prepare a virtual tour/visual representation of the locations in the text.

In some examples, the apparatus may be able to identify locations in a piece of text and associate them with a particular character or narrator in the text. Thus, for example, if a piece of text is processed by the apparatus which describes the journeys made by two people in a story, the apparatus may be able to determine a route for each character individually, and present a visual representation of each route separately for a user. The apparatus would, in this example, associate each determined location with a particular character by identifying the locations with respect to frames identified as relating to a particular character.

An example text is “Jane ran from her house on Broad St across High Lane to meet Jack. As Jack saw Jane in the distance, he left his horse at the corner of Meadow Field and sped to High Lane to see her.” The locations “her house” “Broad St” and “High Lane” may be identified as associated with Jane, for example by using the frame “Jane ran from . . . ”. The route may be determined by identifying words such as “across” in relation to “High Lane”. Similarly, the identified context and locations “corner of” “Meadow Field” and “to High Lane” may be identified and associated with Jack. The two separate routes taken by Jane and Jack may be shown/output on a map or otherwise visually represented for a user.

Another example is of a piece of text describing an extraterrestrial journal, for example a manned mission to the moon. From cues and locations identified in the text, a visual representation of the flight path may be generated and output for the user to view and experience a virtual flight to the moon. Photographs taken from satellites and telescopes may be used to build up the virtual tour, for example.

A further example is the processing of a microblog (e.g., Twitter) stream. A user may be subscribed to receive microblog updates from a number of people. Thus the microblog text may be provided by a number of authors each posting microblog entries which the user can read. The text is updated in near real-time, so as authors post their entries, the user's microblog feed updates to show the new comments/entries.

In this example, an event is taking place about which several authors are posting microblog entries. The event in this example is a marathon is currently in progress. The authors are posting comments about how well the lead runner, Mary Keitany, is running to win the race. The authors may post comments such as: “Go Mary! at the London Eye already! #Keitany #marathon”, “#Keitany is so fast, she's at the 20 k mark already”, and “Mary Keitany is inspirational, so confident running past Nelson's Column”

There may be several hundred authors all posting about Mary Keitany's progress as she runs the race. The apparatus is able to process the microblog postings as they are posted (since it is capable of processing near real-time text).

Contextual information/frames may be mentioned in the microblog feed which the apparatus may identify and use to put the locations in context. Location context information such as “London Eye”, “20 k” and “Nelson's Column” may be used to determine relevant geographical locations. The identity of the person to whom the locations are related can also be identified as a context for the locations, for example, from the text “Mary”, “#Keitany” and “Mary Keitany”. As Mary Keitany progresses through the race, new locations will be mentioned in the microblog text. Other frames used for putting the identified location information in context may include “#marathon” and “running past” for example. A # symbol may denote a hashtag in the microblog feed.

The apparatus may be able to plot Mary Keitany's route along the marathon course as she progresses in (near) real time, so that a user can see a visual representation of her progress. The route may be determined from the combination of identified geographical locations, the context of the locations being mentioned in relation to the runner Mary Keitany (e.g.; “Keitany, or “#Mary K”), and other contextual indicators such as “marathon” and “running”. A visual representation of the route, updating in near real-time, may be provided, for example as a line gradually extending along the course as her progress is mentioned in the microblog feed, or a progressively moving street-level view along the marathon course from Mary Keitany's point of view, for example.

As more authors contribute to the microblog feed, the route may be determined more accurately, as there will be more location and contextual information for the apparatus to obtain and cross check. As more information is made available to the apparatus, it may “learn” to recognise the different ways in which Mary Keitany's name is given (e.g., “Mary”, “Keitany”, “Mary Keitany”, common mis-spellings such as “Mary Kitani” or “Mary Keytani”, and hashtags such as “#gomary” and “#FastMary”) in the microblog feed. The apparatus may therefore become more accurate at determining location information relevant to Mary Keitany as it is able to use location information from a greater number of sources. Thus, the apparatus can process a passage of electronic text, in this case a Twitter feed, to identify at least one word associated with a geographical location (“London Eye”, “Nelson's Column”) in the passage of electronic text. The apparatus also searches for image-based representations of the geographical locations associated with the at least identified words, and outputs the image-based representation (e.g., a map) of the geographical locations to a display.

Generally, text input may be performed by providing the full text in an electronic form for the apparatus to process, (or the apparatus may convert non-electronic text, for example using optical character recognition (OCR) for scanned-in physical text, or a PDF reader to read text from a PDF image. In other examples, the text may be provided by a uniform resource locator (URL) being provided to the apparatus, which may then obtain the text referred to by the URL from the internet or another computer/server.

Advantageously, in the examples mentioned above, the processed text need not be pre-tagged with geo-tag labels in order for locations in the text to be determined. The apparatus is able to parse the text in order to identify the locations. Further, the locations may be determined within a particular context, so that not only can the static locations be identified, but a logical route between the locations may be determined. This is because the apparatus can identify temporal cues (indicating timing and linking locations to each other or to other elements, such as a particular character), and identify frames (indicating a logical context for an identified location). In this way a logical route may be obtained through the locations identified in a piece of text.

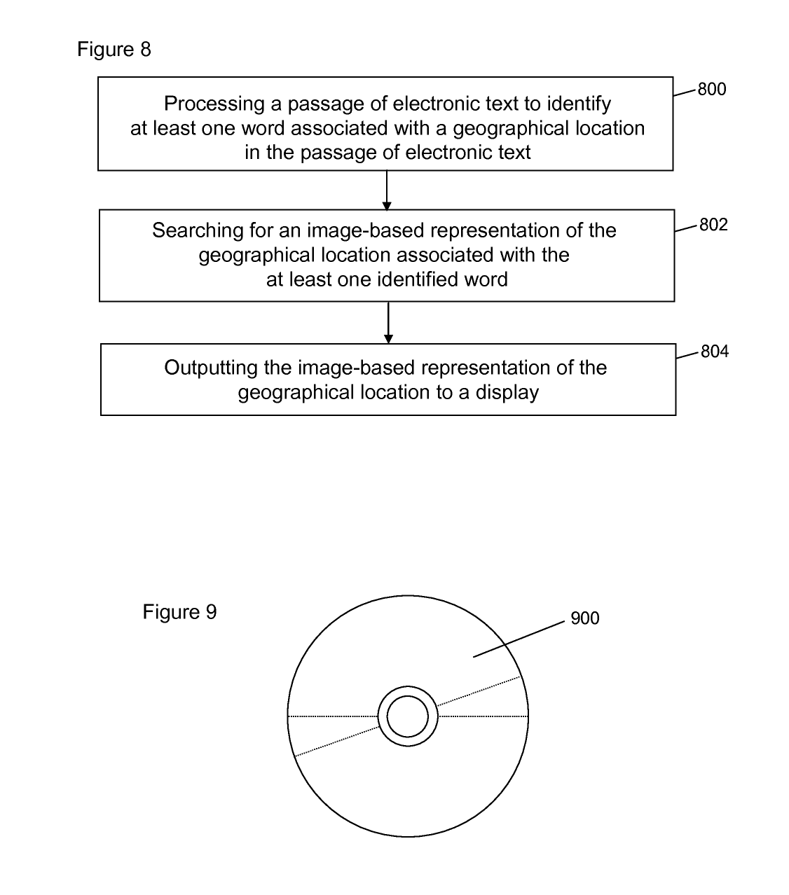

FIG. 8 illustrates a method according to an embodiment of the invention, and shows the steps of processing a passage of electronic text to identify at least one word associated with a geographical location in the passage of electronic text 800; searching for an image-based representation of the geographical location associated with the at least one identified word 802; and outputting the image-based representation of the geographical location to a display 804.

FIG. 9 illustrates schematically a computer/processor readable medium 900 providing a program according to an example. In this example, the computer/processor readable medium is a disc such as a digital versatile disc (DVD) or a compact disc (CD). In other examples, the computer readable medium may be any medium that has been programmed in such a way as to carry out an inventive function. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g., switched on. In such cases, the apparatus/device/server may not necessarily have the appropriate software loaded into the active memory in the non-enabled state (for example, a switched off state) and may only load the appropriate software in the enabled state (for example, an “on” state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device/server may be pre-programmed with the appropriate software to carry out desired operations, wherein the appropriate software can be enabled for use by a user downloading a “key”, for example, to unlock/enable the software and its associated functionality. Advantages associated with such examples can include a reduced requirement to download data when further functionality is required for a device, can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (such as, memory or a signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one or more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (such as ROM, or CD-ROM), these may comprise a computer processor, application specific integrated circuit (ASIC), field-programmable gate array (FPGA), and/or other hardware components that have been programmed in such a way to carry out the inventive function(s).

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures, elements and/or method steps shown and/or described in connection with any disclosed form or examples may be incorporated in any other disclosed or described or suggested form or example as a general matter of design choice. Furthermore means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-26. (canceled)

27. An apparatus comprising:
at least one processor; and
at least one memory, the memory comprising computer program code stored thereon, the at least one memory and computer program code being configured to, when run on the at least one processor, cause the apparatus to:
process a passage of electronic text to identify at least one word associated with a geographical location in the passage of electronic text;
search for an image-based representation of the geographical location associated with the at least one identified word; and
output the image-based representation of the geographical location to a display.

28. The apparatus of claim 27, wherein the electronic text is one of bounded text and unbounded text.

29. The apparatus of claim 27, wherein the at least one word is a single word, a frame, a segment, comprised in a frame, or comprised in a segment.

30. The apparatus of claim 27, wherein the apparatus is caused to identify at least two words each associated with a geographical location in the passage of electronic text; and based on the identified at least two words in the processed passage of electronic text, output an image-based representation of a route formed from the respective identified image-based representations of the identified at least two or more words.

31. The apparatus of claim 30, wherein the apparatus is caused to output an image-based representation of the route formed from the respective identified image-based representations of the identified at least two or more words by searching for the respective image-based representations of the geographical locations and searching for corresponding interconnecting geographical locations for the identified image-based representations to form an interconnected route between the identified image-based representations of the identified at least two or more words, wherein the corresponding interconnecting geographical locations for the identified image-based representations are not explicitly present in the passage of text.

32. The apparatus of claim 30, wherein the apparatus is caused to identify at least two words each associated with a geographical location in the passage of electronic text as being associated with a particular narrator in the passage of electronic text; and
output the image-based representation of a route based on the geographical locations associated with the at least two identified words for the particular narrator.

33. The apparatus of claim 30, wherein the apparatus is caused to output a chronological image-based representation of a route between the geographical locations each associated with at least one identified word, by:
identifying one or more temporal cues in the passage of text; and
using the one or more temporal cues and the geographical locations to output the chronological image-based representation of a route.

34. The apparatus of claim 27, wherein the apparatus is caused to process the passage of electronic text by:
performing a syntactic check of the passage of electronic text to determine a grammatical structure of the text; and
using the determined grammatical structure to identify the at least one word associated with a geographical location within a particular grammatical context in the passage of electronic text, wherein the apparatus is configured to perform the syntactic check of the passage of electronic text by one or more of:
checking the passage of text for temporal cues;
checking the passage of text for geo-bound cues;
checking the passage of text for frames;
checking the passage of text for stop words;
determining a grammar of the passage of text and formally mapping the grammar of the electronic text to a known grammar structure; and
building a transition from the passage of text.

35. The apparatus of claim 27, wherein the apparatus is caused to process the passage of electronic text by:
identifying one or more frames within the passage of electronic text, at least one of the one or more frames comprising the at least one word associated with a geographical location.

36. The apparatus of claim 27, wherein the apparatus is caused to process the passage of electronic text by:
performing a semantic check of the electronic text to determine a meaning of the text; and
using the determined meaning of the text to identify the at least one word associated with a geographical location within a particular semantic context.

37. The apparatus of claim 27, wherein the apparatus is caused to process the passage of electronic text by:
performing sentence extraction to extract one or more sentences from the electronic text; and
using the one or more extracted sentences to identify the at least one word associated with a geographical location within the context of the particular one or more extracted sentences, wherein the apparatus is configured to perform sentence extraction to extract one or more sentences from the electronic text by:
lexical disambiguation of one or more frames identified in the text to minimize ambiguities in the one or more frames;
refining one or more frames identified in the text to minimize ambiguities in the one or more frames; and
checking one or more temporal cues in one or more frames identified in the text to minimize ambiguities in the one or more frames.

38. The apparatus of claim 27, wherein the apparatus is caused to process the passage of electronic text by creating an event vector usable by the apparatus to output, based on the event vector, an image-based representation of the at least one word associated with a geographical location.

39. The apparatus of claim 27, wherein the apparatus is caused to process the passage of electronic text by creating an event vector, the event vector comprising one or more of:
a geographical location identified in the passage of text;
a temporal cue identified in the passage of text;
a geo-bound cue identified in the passage of text;
a frame identified in the passage of text; and
a stop word identified in the passage of text.

40. The apparatus of claim 27, wherein the apparatus is caused to process the passage of electronic text by:
performing geo-filtering of the electronic text to filter out geographical information in the text; and
using the filtered geographical information to identify the at least one word associated with a geographical location in the passage of electronic text and wherein the apparatus is further configured to apply inference rules in one or more processing feedback loops to establish newly detected semantics or syntactic features in the passage of electronic text, in order to identify the at least one word associated with a geographical location in the passage of electronic text.

41. The apparatus of claim 27, wherein the apparatus is caused to process the passage of electronic text to identify at least one word associated with a geographical location by:
comparing of the words in the electronic text against a list of known location words stored in a locations list; and
matching at least one of the words in the electronic text with a known location word stored in the locations list.

42. The apparatus of claim 27, wherein the apparatus is caused to receive the passage of electronic text as input, and wherein the passage of electronic text is one of a static data stream or a fast-moving data stream.

43. The apparatus of claim 27, wherein the apparatus is caused to output an image-based representation of the geographical location associated with the at least one identified word by one or more of:
presenting a user with a map showing the geographical location;
presenting a user with a historical map showing the geographical location based on one or more identified historical temporal cues in the passage of electronic text;
presenting a user with a street-level view of the geographical location;
presenting the user with one or more photographs associated with the geographical location; and
presenting the user with one or more movies associated with the geographical location.

44. The apparatus of claim 27, wherein the passage of electronic text is one or more of: a plain text document, a rich text document, and a spoken word recording,
wherein the apparatus is: a portable electronic device, a mobile telephone, a smartphone, a personal digital assistant, an e-book, a tablet computer, a navigator, a desktop computer, a video player, a television, a user interface or a module for the same and wherein the passage of electronic text is written in at least one of English, Korean, Chinese, Japanese, Arabic, Logographic, Logophonetic, Syllabic, Consonantal Alphabet, Syllabic Alphabet, Segmental Alphabet, pictographic script, ideographic script, analytic transitional script, phonetic script, or alphabetic script types of writing systems

45. A method comprising:
processing a passage of electronic text to identify at least one word associated with a geographical location in the passage of electronic text;
searching for an image-based representation of the geographical location associated with the at least one identified word; and
outputting the image-based representation of the geographical location to a display.

46. A computer readable medium comprising computer program code stored thereon, the computer readable medium and computer program code being configured to, when run on at least one processor, perform at least the following:
process a passage of electronic text to identify at least one word associated with a geographical location in the passage of electronic text;
search for an image-based representation of the geographical location associated with the at least one identified word; and
output the image-based representation of the geographical location to a display.
